(19) United States
(12) Patent Application Publication
(10) Pub. No.: US 2008/0293861 A1
(43) Pub. Date: Nov. 27, 2008

(54) Composition of high impact glass fiber reinforced engineering plastic and preparation method thereof

(75) Inventor: Yang Wang, Foshan City (CN)

Correspondence Address: RABIN & Berdo, PC, 1101 14TH STREET, NW, SUITE 500, WASHINGTON, DC, 20005, US

(73) Assignee: Mitac Precision Technology (Shunde) Ltd., Foshan City (CN)

(21) Appl. No.: 11/889,275

(22) Filed: Aug. 10, 2007

(30) Foreign Application Priority Data
May 25, 2007 (CN) 200710028219.2

(51) Int. Cl. C08K 3/40; C08F 212/10

(52) U.S. Cl. 524/323; 524/502

(57) ABSTRACT

A composition of a high impact glass fiber reinforced engineering plastic and a preparation method thereof, including except for glass fiber, from 30% to 70% by weight of a polyamide6 (PA6), from 15% to 25% by weight of an acrylonitrile-butadiene-styrene copolymer (ABS), from 4% to 6% by weight of a compatilizer, from 0.3% to 0.5% by weight of an antioxidant, and from 0.3% to 0.6% by weight of a lubricant are firstly added into a high-speed mixer and then mixed for 2-5 min. The blend composition is fed into a twin screw extruder, and from 10% to 30% by weight of a glass fiber is added into the twin screw extruder at the second half stage, and ground together to be granulated and molded. During the preparation, the process temperature is from 180° C. to 245° C., the screw rotating speed is from 240 rpm to 560 rpm.

### CROSS-REFERENCE TO RELATED APPLICATIONS

This non-provisional application claims priority under 35 U.S.C. § 119(a) on Patent Application No(s). 200710028219.2 filed in China on May 25, 2007, the entire contents of which are hereby incorporated by reference.

### BACKGROUND OF THE INVENTION

1. Field of Invention

The present invention relates to plastic modification treatment, and more particularly to a polyamide6/acrylonitrile-butadiene-styrene copolymer (PA6/ABS) alloy and a method for preparing high impact glass fiber reinforced engineering plastic.

2. Related Art

Currently, the PA/ABS alloy can integrate the crystallinity of PA (polyamide) and the noncrystallinity of ABS (acrylonitrile-butadiene-styrene) and has the characteristics of good mouldability, low water absorption, dimensional stability, chemical resistance, oil resistance, thermal stability, slip resistance, and abrasion resistance, so it is an ideal material for manufacturing auto parts, such as auto body sheets and the like.

Though PA6 has the advantages of abrasion resistance, solvent resistance, oil resistance, and wide application temperature range, and at the same time, it still has the disadvantages of high water absorption, poor dimensional stability, and insufficient low-temperature and dry-state impact strength, thus the application of PA6 is heavily limited. An alloy can be made by blending PA6 and ABS, which not only has the flexibility of ABS, but also has the thermal stability and oil resistance of PA6. Therefore, the alloy is widely applied in the fields of electric and electronic appliances, autos, household appliances, and sports products, and has drawn a lot of attention in recent years. However, PA6 is a polymer having crystallinity, high polarity, and extremely low melt viscosity, while ABS is a polymer having noncrystallinity and low polarity, and the difference in the solubility parameters thereof is large, so PA6 and ABS are thermodynamically incompatible, thus simple blending will result in a large interfacial tension between the two phases, which will lead to poor mechanical properties.

### SUMMARY OF THE INVENTION

The present invention is directed to providing a composition of a high impact glass fiber reinforced PA6/ABS alloy having characteristics of high dimensional stability, high mechanical strength, and greater thermal stability.

The present invention discloses a composition of a high impact glass fiber reinforced engineering plastic, including the following compositions expressed by weight percentage:

| | |
|---|---|
| polyamide6 (PA6) | 30%-70%; |
| acrylonitrile-butadiene-styrene copolymer (ABS) | 15%-25%; |
| compatilizer | 4%-6%; |
| glass fiber | 10%-30%; |
| antioxidant | 0.3%-0.5%; |
| lubricant | 0.3%~0.6%. |

The relative viscosity of PA6 is from 2.4 Pa·s to 3.6 Pa·s. The rubber content of the ABS is from 35% to 70%. The compatilizer is acrylonitrile-butadiene-styrene graft maleic anhydride (ABS-g-MAH), styrene-maleic anhydride random copolymer (SMA), or styrene-maleic anhydride-acrylonitrile tri-component random copolymer (SAM). The glass fiber is a non-alkali glass fiber, and has a surface treated by a silane coupling agent KH550. The antioxidant is a composite of a hindered phenolic antioxidant and a phosphate antioxidant, and a weight ratio of the composite of the hindered phenolic antioxidant and the phosphate antioxidant is 1010/168 (1:1). The lubricant is ethylene bisstearamide with a polar group.

The preparation method of the present invention includes raw materials, except for glass fiber, are added into a high-speed mixer in proportion and mixed for 2-5 min; next, the blend composition is fed into a twin screw extruder, and glass fiber are added in proportion into the twin screw extruder at the second half stage, and ground together to be granulated and molded. During the preparation, the process temperature is from 180° C. to 245° C., the screw rotating speed is from 240 rpm to 560 rpm.

PA6 has the advantages of abrasion resistance, solvent resistance, oil resistance, and wide application temperature range, and ABS integrates the glossiness and mouldability of styrene, the rigidity and chemical resistance, as well as excellent mechanical properties of acrylonitrile, and the impact resistance of butadiene, thereby the dimensional stability, impact strength, chemical resistance, and processability of PA6 can be improved by blending PA6 with ABS.

Since PA6 and ABS are thermodynamically incompatible, the compatibility thereof can be greatly improved by adding a compatilizer, thus the problem of thermodynamics incompatibility is solved, and the comprehensive mechanical properties of the alloy are improved.

The antioxidant is a composite of a hindered phenolic antioxidant and a phosphate antioxidant, and the composite of the hindered phenolic antioxidant and the phosphate antioxidant can be 1010/168 (1:1), and mainly prevents the oxidation of PA6.

The glass fiber can significantly improve the thermal stability and mechanical properties of the materials.

The lubricant is ethylene bisstearamide (TAF) with a polar group, and can improve the processing flowability and prevent the glass fiber from being exposed.

Compared with the prior art, the high impact glass fiber reinforced engineering plastic of the present invention made by the above compositions has the characteristics of high dimensional stability, high mechanical strength, and high impact strength.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The present invention is further described in detail with reference to the following embodiments.

SAM (styrene-maleic anhydride-acrylonitrile tri-component random copolymer) is used as the compatilizer, 1010/168 (1:1) is used as the antioxidant, and the TAF (ethylene bisstearamide with a polar group) is used as the lubricant.

### Embodiment 1

The raw materials, such as PA6, ABS, SAM, 1010/168 (1:1), and TAF, were added into a high-speed mixer to be blended in the following proportion by weight:

| | |
|---|---|
| PA6 | 65%; |
| ABS | 18%; |
| SAM | 4%; |
| 1010/168 (1:1) | 0.4%; |
| TAF | 0.6%. |

Next, the blend composition was fed into a twin screw extruder, and 12% by weight of glass fiber were added in to the twin screw extruder at the second half stage to be ground and granulated, in which the process temperature was 240° C., and the screw rotating speed was 300 rpm; then the blend composition was injection molded, to obtain a standard sample; finally, the mechanical properties of the resulted product were tested according to the national standard GB 13525/T-92. The test results are listed in Table 1.

TABLE 1
Test data of properties of the resulted alloy according to Embodiment 1

| | High impact glass fiber |
|---|---|
| | reinforced PA6/ABS |
| Notched Impact Strength (kJ/M²) | 16.8 |
| Tensile Strength (MPa) | 80.7 |
| Bending Strength (MPa) | 106.2 |

### Embodiment 2

The raw materials, such as PA6, ABS, SAM, 1010/168 (1:1), and TAF, were added into a high-speed mixer to be blended in the following proportion by weight:

| | |
|---|---|
| PA6 | 57%; |
| ABS | 21%; |
| SAM | 4%; |
| 1010/168 (1:1) | 0.4%; |
| TAF | 0.6%. |

Next, the blend composition was fed into a twin screw extruder, and 17% by weight of glass fiber were added in to the twin screw extruder at the second half stage to be ground and granulated, in which the process temperature was 240° C., and the screw rotating speed was 300 rpm; then the blend composition was injection molded, to obtain a standard sample; finally, the mechanical properties of the resulted product were tested according to the national standard GB 13525/T-92. The test results are listed in Table 2.

TABLE 2
Test data of properties of the resulted alloy according to Embodiment 2

| | High impact glass fiber |
|---|---|
| | reinforced PA6/ABS |
| Notched Impact Strength (kJ/M²) | 18.1 |
| Tensile Strength (MPa) | 82.5 |
| Bending Strength (MPa) | 118.8 |

### Embodiment 3

The raw materials, such as PA6, ABS, SAM, 1010/168 (1:1), and TAF, were added into a high-speed mixer to be blended in the following proportion by weight:

| | |
|---|---|
| PA6 | 44%; |
| ABS | 23%; |
| SAM | 4%; |
| 1010/168 (1:1) | 0.4%; |
| TAF | 0.6%. |

Next, the blend composition was fed into a twin screw extruder, and 28% by weight of glass fiber were added in to the twin screw extruder at the second half stage to be ground and granulated, in which the process temperature was 240° C., and the screw rotating speed was 300 rpm; then the blend composition was injection molded, to obtain a standard sample; finally, the mechanical properties of the resulted product were tested according to the national standard GB 13525/T-92. The test results are listed in Table 3.

TABLE 3
Test data of properties of the resulted alloy according to Embodiment 3

| | High impact glass fiber |
|---|---|
| | reinforced PA6/ABS |
| Notched Impact Strength (kJ/M²) | 22.2 |
| Tensile Strength (MPa) | 111.1 |
| Bending Strength (MPa) | 148.8 |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A composition of a high impact glass fiber reinforced engineering plastic, comprising:
from 30% to 70% by weight of a polyamide6;
from 15% to 25% by weight of an acrylonitrile-butadiene-styrene copolymer;
from 4% to 6% by weight of a compatilizer;
from 10% to 30% by weight of a glass fiber;
from 0.3% to 0.5% by weight of a antioxidant; and
from 0.3% to 0.6% by weight of a lubricant.

2. The composition of the high impact glass fiber reinforced engineering plastic as claimed in claim 1, wherein the compatilizer comprises acrylonitrile-butadiene-styrene graft maleic anhydride, styrene-maleic anhydride random copolymer and styrene-maleic anhydride-acrylonitrile tri-component random copolymer.

3. The composition of the high impact glass fiber reinforced engineering plastic as claimed in claim 1, wherein a relative viscosity of the polyamide6 is from 2.4 Pa·s to 3.6 Pa·s.

4. The composition of the high impact glass fiber reinforced engineering plastic as claimed in claim 1, wherein a rubber content of the acrylonitrile-butadiene-styrene copolymer is from 35% to 70% by weight.

5. The composition of the high impact glass fiber reinforced engineering plastic as claimed in claim 1, wherein the glass fiber comprises a non-alkali glass fiber and the non-alkali glass fiber has a surface treated by a silane coupling agent.

6. The composition of the high impact glass fiber reinforced engineering plastic as claimed in claim 1, wherein the antioxidant comprises a composite of a hindered phenolic antioxidant and a phosphate antioxidant and a weight ratio of the composite of the hindered phenolic antioxidant and the phosphate antioxidant is 1010/168 (1:1).

7. The composition of the high impact glass fiber reinforced engineering plastic as claimed in claim 1, wherein the lubricant comprises an ethylene bisstearamide with a polar group.

8. A method for preparing a high impact glass fiber reinforced engineering plastic, comprising:
adding from 30% to 70% by weight of a polyamide6, from 15% to 25% by weight of an acrylonitrile-butadiene-styrene copolymer, from 4% to 6% by weight of a compatilizer, from 0.3% to 0.5% by weight of an antioxidant, and from 0.3% to 0.6% by weight of a lubricant into a high-speed mixer, and mixing for 2-5 min;
feeding the blend composition into a twin screw extruder, and adding from 10% to 30% by weight of a glass fiber into the twin screw extruder at the second half stage; and
grinding to granulate and mold, wherein a process temperature is from 180° C. to 245° C., and a screw rotating speed is from 240 rpm to 560 rpm.

9. The method for preparing a high impact glass fiber reinforced engineering plastic of claim 8, wherein a relative viscosity of the polyamide6 is from 2.4 Pa·s to 3.6 Pa·s.

10. The method for preparing a high impact glass fiber reinforced engineering plastic of claim 8, wherein a rubber content of the acrylonitrile-butadiene-styrene copolymer is from 35% to 70% by weight.

11. The method for preparing a high impact glass fiber reinforced engineering plastic of claim 8, wherein the glass fiber comprises a non-alkali glass fiber and the non-alkali glass fiber has a surface treated by a silane coupling agent.

12. The method for preparing a high impact glass fiber reinforced engineering plastic of claim 8, the antioxidant comprises a composite of a hindered phenolic antioxidant and a phosphate antioxidant, and a weight ratio of the composite of the hindered phenolic antioxidant and the phosphate antioxidant is 1010/168 (1:1).
